(19) United States
(12) Patent Application Publication
(10) Pub. No.: US 2015/0035535 A1
(43) Pub. Date: Feb. 5, 2015

(54) Apparatus and Method for At-Bit Resistivity Measurements

(71) Applicants: Naizhen Liu, Beijing (CN); Qihui Zhao, Beijing (CN); Yuzhou Lu, Beijing (CN); Yonghe Li, Panjin (CN); Rui Bai, Panjin (CN); Jing Li, Houston, TX (US); Ce Liu, Houston, TX (US)

(72) Inventors: Naizhen Liu, Beijing (CN); Qihui Zhao, Beijing (CN); Yuzhou Lu, Beijing (CN); Yonghe Li, Panjin (CN); Rui Bai, Panjin (CN); Jing Li, Houston, TX (US); Ce Liu, Houston, TX (US)

(21) Appl. No.: 13/957,365

(22) Filed: Aug. 1, 2013

(51) Int. Cl. G01V 3/12

(52) U.S. Cl. CPC G01V 3/12
USPC 324/338

(57) ABSTRACT

An apparatus for making resistivity measurements near a drill bit includes a tool body, a transmitter deployed on the tool body, a receiver deployed on the tool body and at an axial distance from the transmitter, and a transmitting signal coupler coupled to the transmitter antenna and the receiver. The transmitter generates electrical signals and converts the electrical signals into electromagnetic signals to be transmitted. The receiver measures the amplitudes and phases of the electromagnetic signals received from the transmitter. The transmitting signal coupler couples a portion of the electrical signals from the transmitter antenna and measures the amplitudes and phases of the coupled electrical signals. Amplitude attenuation and phase shift between the electromagnetic signals received at the receiver and the electrical signals coupled at the transmitting signal coupler are computed for calculating resistivity.

### FIELD OF THE INVENTION

The present invention relates generally to the field of electrical resistivity well logging. More particularly, the invention relates to an apparatus and a method for making at-bit resistivity measurements of a subterranean formation adjacent a wellbore.

### BACKGROUND OF THE INVENTION

The use of electrical measurements for gathering of downhole information, such as logging while drilling (“LWD”), measurement while drilling (“MWD”), and wireline logging system, is well known in the oil industry. Such technology has been utilized to obtain earth formation resistivity (or conductivity; the terms “resistivity” and “conductivity”, though reciprocal, are often used interchangeably in the art.) and various rock physics models (e.g. Archie's Law) can be applied to determine the petrophysical properties of a subterranean formation and the fluids therein accordingly. As known in the prior art, the resistivity is an important parameter in delineating hydrocarbon (such as crude oil or gas) and water contents in the porous formation. It is preferable to keep the borehole in the pay zone (the formation with hydrocarbons) as much as possible so as to maximize the recovery.

A conventional bottom hole drilling assembly (“BHA”) 100 can include a drill bit 114, an at-bit sensor unit 110, one or more stabilizer 104, a mud motor 108, a LWD sensor system 106, and a drill collar 102 as shown in FIG. 1 as part of a drilling string for drilling operation. The at-bit sensor unit 110 can include compact sensors necessary for the BHA 100 to monitor and guide the drilling operation, for example, a bit orientation sensor, Gamma ray reader, and a telemetry transmitter 112. The at-bit sensor unit 110 can sense at-bit environmental conditions and send at-bit information to the LWD system 106 to decide the next move of the BHA 100. The mud motor 108 is for driving the drill bit 114 during drilling operation. The LWD system 106 can include various types of logging tools, such as a resistivity tool, an acoustic tool, a neutron tool, a density tool, a telemetry system. The telemetry system, i.e. a mud pulse telemetry system, can establish a communication link from the LWD system 106 to the surface (not shown in FIG. 1), being a relay for the at-bit information or other measured data to be sent to the surface.

The at-bit information can include information in regards to environmental conditions of a surrounding subterranean near the drill bit 114, which becomes important operational and directional parameters for the driller to adjust its direction in wellbore drilling on a real time basis.

Due to the mechanical complexity and limited space near the drill bit 114, the LWD system 106 can not be disposed near the drill bit 114 directly but has to be placed above the mud motor 108 and away from the drill bit 114 at least 30 feet. For example, a conventional propagation logging tool 200 as shown in FIG. 2 as a part of the LWD system 106 usually can not be placed near the drill bit 114. The propagation logging tool 200 includes a tool body 202, a transmitter T1, and a pair of receivers R1 and R2. The transmitter T1 is configured to transmit electromagnetic signals through formation to the pair of receivers R1 and R2. The phase shifts and amplitude attenuation between induced electromagnetic signals on the pair of receivers R1 and R2 can be used to calculate surrounding formation resistivity. Large phase shift and amplitude attenuation of signals can indicate low formation resistivity.

However, the above propagation logging tool 200 shall be positioned above the mud motor 108 for the concern of limited space around the drill bit 114. As a result, the propagation logging tool 200 may have a problem of lag on measurements of environmental conditions around the drill bit 114 (the distance between the drill bit 114 and the propagation logging tool 200 could be 30 feet or more).

As described above, a need exists for an improved apparatus and method for measurements of environmental conditions of formation around a drill bit.

A further need exists for an improved apparatus and method for measurements of resistivity of surrounding formation utilizing a compact propagation logging tool.

The present embodiments of the apparatus and the method meet these needs and improve on the technology.

### SUMMARY OF THE INVENTION

This section provides a general summary of the disclosure, and is not a comprehensive disclosure of its full scope or its entire feature.

In one preferred embodiment, an apparatus for making resistivity measurements near a drill bit includes a tool body, a transmitter deployed on the tool body, a receiver deployed on the tool body and at an axial distance from the transmitter, and a transmitting signal coupler coupled to the transmitter antenna and the receiver. The transmitter generates electrical signals and converts the electrical signals into electromagnetic signals to be transmitted into a formation. The receiver measures the amplitudes and phases of the electromagnetic signals shed from the formation. The transmitting signal coupler couples a portion of the electrical signals directly from the transmitter antenna and measures the amplitudes and phases of the coupled electrical signals. An amplitude attenuation and a phase shift between the electromagnetic signals received at the receiver and the electrical signals coupled at the transmitting signal coupler are computed for calculating resistivity.

In some embodiments, the transmitter and the receiver include at least one antenna for transmitting or receiving electromagnetic signals.

In some embodiments, the antenna is for converting electrical signals into electromagnetic signals or converting electromagnetic signals into electrical signals.

In some embodiments, the transmitter includes a transmitter circuit configured to generate and amplify the electrical signals.

In some embodiments, the transmitter circuit includes an impedance tuning circuit configured to adjust antenna impedance within the transmitter.

In some embodiments, the receiver includes a receiver circuit configured to process data of the amplitudes and phases of the electromagnetic signals from the transmitter.

In other embodiments, the transmitting signal coupler includes a coupling circuit configured to record the electrical signals coupled from the transmitter antenna and help measure the amplitudes and phases of them.

In other embodiments, the apparatus further includes a controller and processor module coupled to the transmitting signal coupler or the receiver to calculate the amplitude attenuation and phase shift between the amplitudes and phases of the electromagnetic signals received at the receiver and the electrical signals coupled at the transmitting signal coupler.

In other embodiments, the controller and processor module is coupled with a storage device stored with a conversion chart for converting the computed amplitude attenuation and phase shift into corresponding formation resistivity.

In one preferred embodiment, a method for formation resistivity measurements near a drill bit includes deploying a tool body in a borehole, firing a transmitter to transmit electromagnetic signals into a formation, utilizing a transmitting signal coupler to measure the amplitudes and phases of electrical signals generated on the transmitter antenna, utilizing a receiver to measure the amplitudes and phases of the electromagnetic signals sourced from the transmitter, and computing amplitude attenuation and phase shift based on the amplitudes and phases of the electrical signals measured at the transmitting signal coupler and the electromagnetic signals induced at the receiver.

In some embodiments, the method further includes providing a conversion chart to facilitate converting the computed amplitude attenuation and phase shift into corresponding resistivity.

In some embodiments, firing a transmitter to transmit electromagnetic signals into the formation includes converting the electrical signals on the transmitter into the corresponding electromagnetic signals.

In some embodiments, utilizing a transmitting signal coupler to measure the amplitudes and phases of electrical signals generated on the transmitter antenna includes utilizing the transmitting signal coupler to couple the electrical signals from the transmitter antenna.

In some embodiments, the amplitude attenuation between the amplitudes of the electrical signals measured at the transmitting signal coupler and the electromagnetic signals induced at the receiver is expressed by an equation

ρ=20 log(kA/A₀)

where A is the amplitude of the induced electromagnetic signals at the receiver; k is the geometry factor of the tool body that can be determined by calibration; and A₀ is the amplitude of the electrical signals measured at the transmitting signal coupler.

In other embodiments, A is expressed by an equation

A=Ilωμ₀/(16π³)

where I is current generated on the transmitter antenna; l denotes a perimeter of an antenna of the transmitter; ω is the signal angular frequency; and μ₀ is a permeability of free space.

In other embodiments, the phase shift between the phases of the electrical signals measured at the transmitting signal coupler and the electromagnetic signals induced at the receiver is expressed by an equation

Δφ=φ−φ₀

where φ is the phase of the induced electromagnetic signals at the receiver; φ₀ is the phase of the electrical signals measured at the transmitting signal coupler.

In another preferred embodiment, an apparatus for making at-bit resistivity measurements includes a tool body, a transmitter deployed on the tool body, a receiver deployed on the tool body and at an axial distance from the transmitter, a transmitting signal coupler coupled to the transmitter antenna, and a controller and processor module coupled to the transmitter, the receiver and the transmitting signal coupler for controlling a measurement operation and computing an amplitude attenuation and a phase shift between the electromagnetic signals induced at the receiver and the electrical signals coupled at the transmitting signal coupler. The transmitting signal coupler couples a portion of the electrical signals from the transmitter antenna and measures the amplitudes and phases of the coupled electrical signals. The transmitter generates electrical signals and converts the electrical signals into electromagnetic signals to be transmitted into the formation. The receiver measures the amplitudes and phases of the electromagnetic signals sourced from the transmitter.

In some embodiments, the apparatus further includes a storage device coupled to the controller and processor module and stored with a conversion chart to convert the computed amplitude attenuation and phase shift into corresponding resistivity.

In other embodiments, the transmitter and the receiver include at least one antenna each.

In still other embodiments, the transmitter includes a transmitter circuit configured to generate and amplify electrical signals.

### BRIEF DESCRIPTION OF THE DRAWINGS

The drawings described herein are for illustrating purposes only of selected embodiments and not all possible implementation and are not intended to limit the scope of the present disclosure.

The detailed description will be better understood in conjunction with the accompanying drawings as follows:

FIG. 1 illustrates a prior art of a conventional bottom hole drilling assembly (“BHA”) as a part of a drilling string.

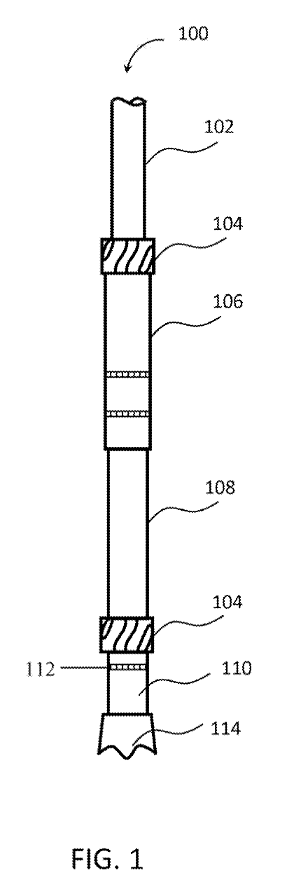

FIG. 2 illustrates a prior art of a propagation logging tool.

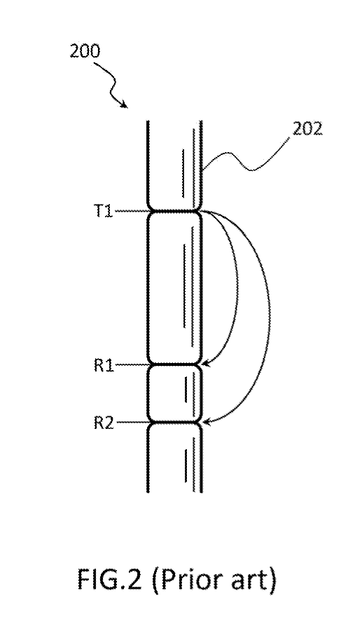

FIG. 3A illustrates a perspective view of a tool body deployed with a transmitter, a transmitting signal coupler, and a receiver according to some embodiments of the present invention.

FIG. 3B illustrates a schematic presentation, partially in block diagram form, of an apparatus including a transmitter, a transmitting signal coupler, and a receiver according to some embodiments of the present invention.

FIG. 3C illustrates a schematic presentation, partially in block diagram form, of an apparatus including a transmitter, a transmitting signal coupler, a receiver, a controller and processor module, and a storage device according to some embodiments of the present invention.

FIG. 4 illustrates a conversion chart in term of a data graph of phase shift versus formation resistivity.

FIG. 5 illustrates a conversion chart in term of a data graph of attenuation versus formation resistivity.

FIG. 6 illustrates a flow chart of a method for at-bit resistivity measurements.

The present embodiments are detailed below with reference to the listed Figures.

### DETAILED DESCRIPTION OF THE EMBODIMENTS

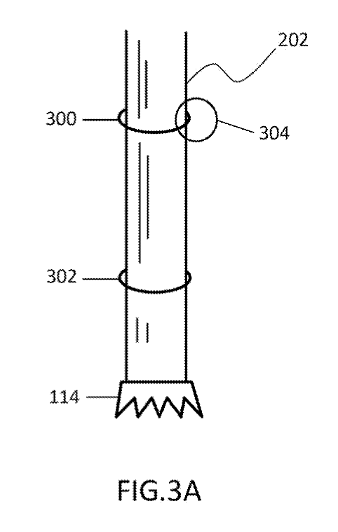

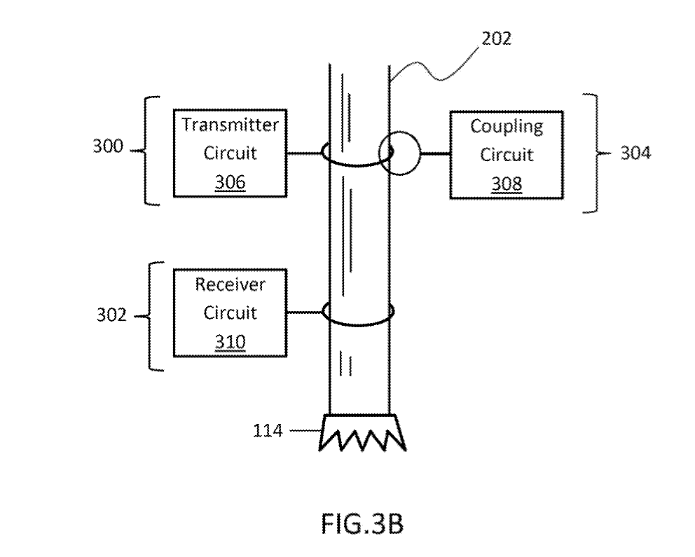

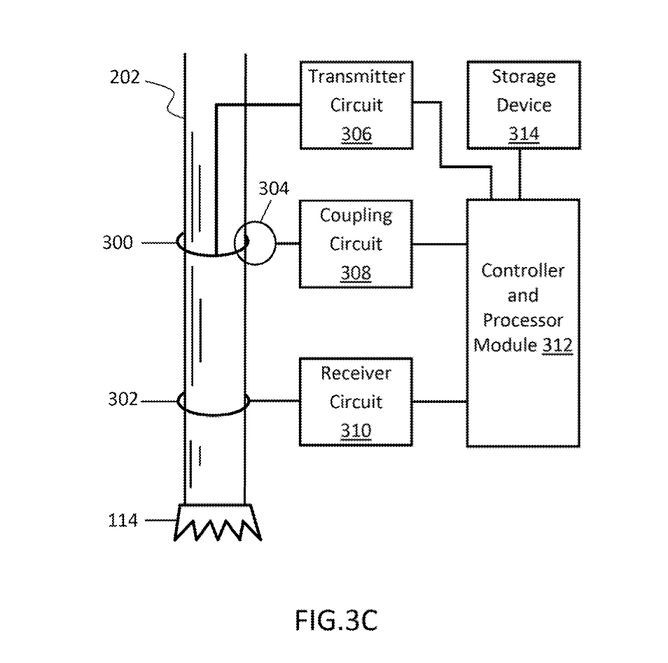

FIG. 3A illustrates a perspective view of a tool body 202 deployed with a transmitter 300, a transmitting signal coupler 304, and a receiver 302, all of which are near a drill bit 114 for at-bit resistivity measurements according to some embodiments of the present invention. The transmitter 300 and the receiver 302 can include at least one antenna to transmit/receive electromagnetic signals and/or convert electrical/electromagnetic signals into electromagnetic/electrical signals.

FIG. 3B illustrates a schematic presentation, partially in block diagram form, of an apparatus including the transmitter 300, the transmitting signal coupler 304, and the receiver 302 according to some embodiments of the present invention. The transmitter 300 can transmit electromagnetic signals through surrounding formation to initiate a resistivity measurement process. The transmitter 300 can include a transmitter circuit 306 which can be configured to generate and/or amplify electrical signals. Such electrical signals can be converted into corresponding electromagnetic signals to be transmitted into surrounding formation. The transmitting signal coupler 304 can be coupled with the transmitter 300 and configured to couple a small portion of the electrical signals from the antenna of the transmitter 300. The transmitting signal coupler 304 can include a coupling circuit 308 which can be configured to record such coupled electrical signals from the transmitter 300 and measure the amplitudes and phases of them. The receiver 302, which is at an axial distance from the transmitter 300, can receive the electromagnetic signals sourced from the transmitter 300. The receiver 302 can include a receiver circuit 310 which can be configured to measure the amplitudes and phases of the received electromagnetic signals.

In some embodiments, the receiver 302 or the transmitting signal coupler 304 can include a controller and processor module 312 (not shown in FIG. 3B) to control the measurements and compute the amplitude attenuation and phase shift between the electromagnetic signals induced at the receiver 302 and the electrical signals coupled at the transmitting signal coupler 304.

FIG. 3C illustrates a schematic presentation, partially in block diagram form, of an apparatus including the transmitter 300, the transmitting signal coupler 304, the receiver 302, the controller and processor module 312, and the storage device 314 according to some embodiments of the present invention. The transmitter 306, the transmitting signal coupler 304, and the receiver 302 can be connected with the controller and processor module 312. The controller and processor module 312 can include a controller configured to control the operation of the system.

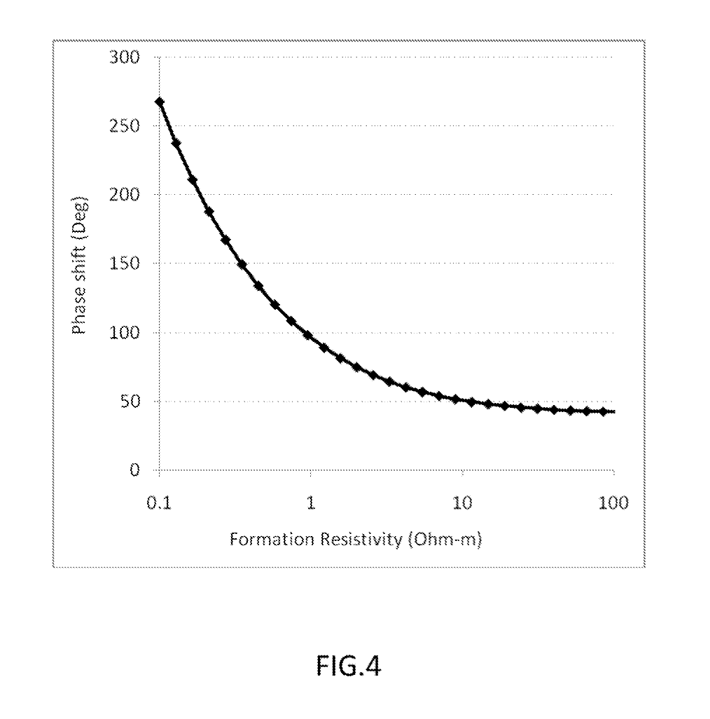

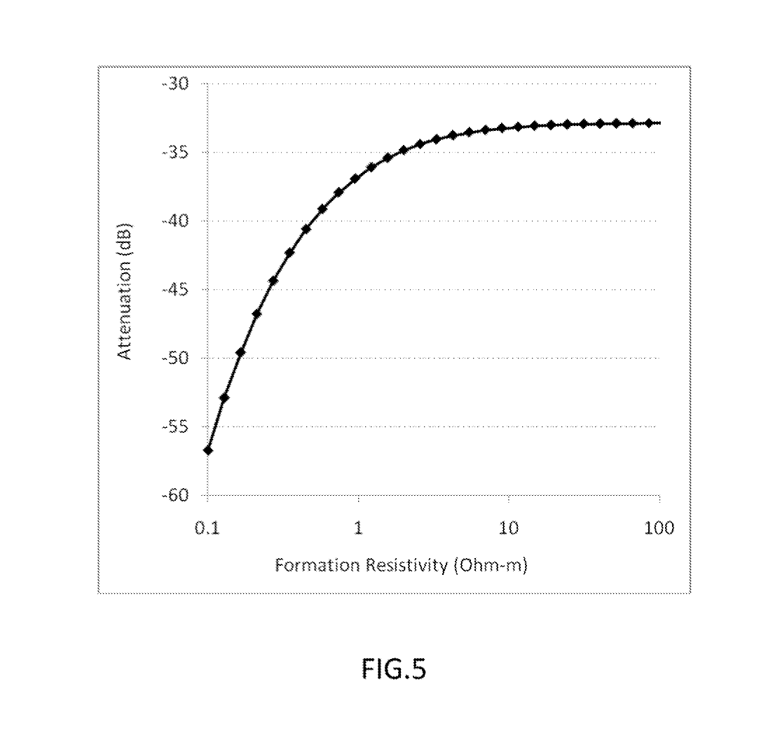

In some embodiments, a storage device 314 can be coupled to the controller and processor module 312 and stored with a conversion chart, which is for converting the computed amplitude attenuation and phase shift into corresponding formation resistivity. FIG. 4 and FIG. 5 are exemplary conversion charts in terms of data graphs of attenuation and phase shift versus formation resistivity.

In some embodiments, the transmitter circuit 306 can include an impedance tuning circuit 316 (not shown in FIG. 3A-3C) to adjust the input impedance of the antenna of the transmitter 300 to match the output impedance of the transmitter circuit 306.

The present invention is in no way to limited to the number and location of transmitter, receiver, and transmitting signal coupler.

According to the electromagnetic theory, the magnetic field generated by an antenna can be expressed as Equation (1).

$$\vec{B} ( \vec{r} ) = \frac{{μ}_{0}}{4 π} [ \frac{3 \vec{r} ( \vec{m} \cdot \vec{r} )}{{r}^{5}} - \frac{\vec{m}}{{r}^{3}} ] {e}^{- jkr} \qquad ( 1 )$$

where \tilde{B}(\tilde{r}) represents the generated magnetic flux density at observation position \tilde{r}; r is the distance from the center of the antenna to the observation location; k is complex wave number; \tilde{m} denotes the magnetic momentum of the antenna; k and \tilde{m} can be expressed by Equations (2) and (3) below.

\tilde{m}=\hat{n}S·Ie^{-lφ}₀ (2)

where \hat{n} is the unit vector pointing the normal direction of the antenna surface; S denotes the area of the antenna surface; I is the current amplitude in the antenna; and φ₀ is the phase of the current

$$k = ω \sqrt{{ɛ}_{r} {ɛe}_{0} {μ}_{0} - \frac{j {σμ}_{0}}{ω}} = - \frac{ω \sqrt{{ɛ}_{0} {μ}_{0}}}{\sqrt{2}} \{ \sqrt{\sqrt{{ɛ}_{r}^{2} + \frac{{σ}^{2}}{{ω}^{2} {ɛ}_{0}^{2}}} + {ɛ}_{r}} - j \sqrt{\sqrt{{ɛ}_{r}^{2} + \frac{{σ}^{2}}{{ω}^{2} {ɛ}_{0}^{2}}} - {ɛ}_{r}} \} \qquad ( 3 )$$

where ω is the signal angular frequency; σ denotes the conductivity of the formation; ∈₀ is the dielectric constant of free space; ∈ᵣ is the relative dielectric constant for formation; and μ₀ is the permeability of free space.

Equation (4) can be computed by substituting Equations (2) and (3) into Equation (1) as follows.

$$\begin{matrix}\vec{B} ( \vec{r} ) = \frac{{μ}_{0} S \cdot I}{4 π} [ \frac{\vec{r} ( \hat{n} \cdot \vec{r} )}{{r}^{5}} - \frac{\hat{n}}{{r}^{3}} ] \cdot {e}^{- β r} \cdot {e}^{- j ( α r + {φ}_{e} )} & ( 4 ) \\ where α = \frac{ω \sqrt{{ɛ}_{0} {μ}_{0}}}{\sqrt{2}} \sqrt{\sqrt{{ɛ}_{r}^{2} + \frac{{σ}^{2}}{{ω}^{2} {ɛ}_{0}^{2}}} + {ɛ}_{r}} & ( 5 ) \\ where β = \sqrt{\sqrt{{ɛ}_{r}^{2} + \frac{{σ}^{2}}{{ω}^{2} {ɛ}_{0}^{2}}} - {ɛ}_{r}} & ( 6 )\end{matrix}$$

In conductive formation, Equations (5-6) can be simplified for low frequency signals as Equation (7) below.

$$α = β \approx \frac{\sqrt{{ωμ}_{0} σ}}{\sqrt{2}} \qquad ( 7 )$$

Equations (1-7) show that the magnetic field generated by an antenna is a function of the electrical property, specifically the conductivity σ for low frequency signals, when the propagation distance r, the antenna current amplitude I, and the antenna current phase φ₀ are known or measured in advance. The current amplitude and phase can be determined by multiple factors, such as transmitter circuitry and surrounding temperature.

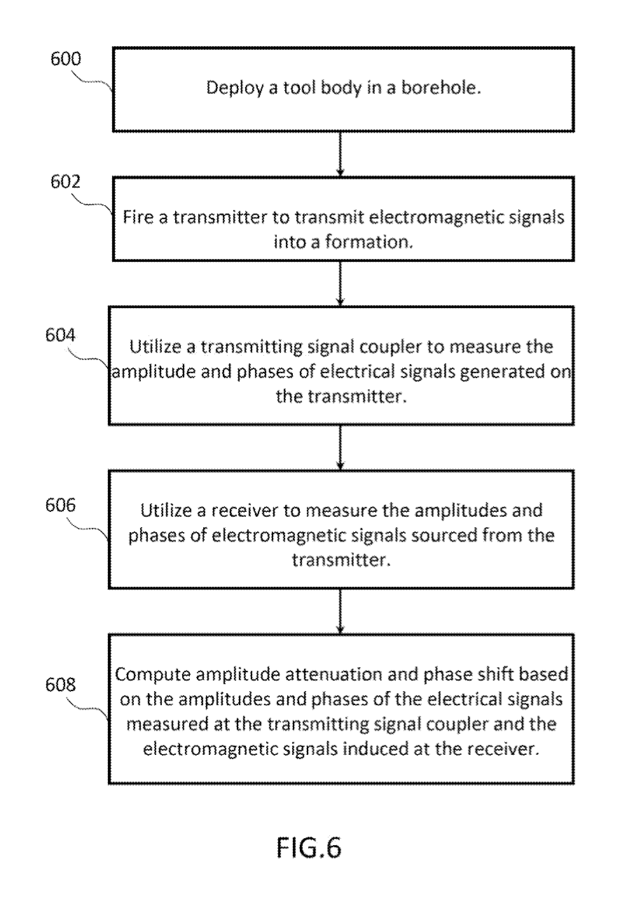

FIG. 6 illustrates a flow chart of a method for formation resistivity measurements near a drill bit. The method for formation resistivity measurements near a drill bit includes deploying a tool body in a borehole 600, firing a transmitter to transmit electromagnetic signals 602 into a formation, utilizing a transmitting signal coupler to measure the amplitudes and phases of electrical signals generated on the transmitter 604, utilizing a receiver to measure the amplitudes and phases of the electromagnetic signals sourced from the transmitter 606, and computing amplitude attenuation and phase shift based on the amplitudes and phases of the electrical signals measured at the transmitting signal coupler and the electromagnetic signals induced at the receiver 608.

In some embodiments, the method of formation resistivity measurements near a drill bit further includes the step of providing a conversion chart to facilitate a conversion from the computed amplitude attenuation and phase shift into corresponding formation resistivity.

In some embodiments, the step of firing a transmitter to transmit electromagnetic signals into the formation includes converting electrical signals on the transmitter into corresponding electromagnetic signals.

In some embodiments, the step of utilizing a transmitting signal coupler to measure the amplitudes and phases of electrical signals generated on the transmitter includes utilizing the transmitting signal coupler to couple electrical signals from the transmitter.

In some embodiments, the amplitude attenuation between the amplitudes of the electrical signals measured at the transmitting signal coupler and the electromagnetic signals induced at the receiver can be expressed as Equation (8) below.

ρ=20 log(kA/A₀) (8)

where A is the amplitude of the induced electromagnetic signals at the receiver; k is a geometry factor of the tool body, and A₀ is the amplitude of the electrical signals measured at the transmitting signal coupler and can be shown in Equation (9) below.

A₀=Ilωμ₀/(16π³) (9)

where I is the current generated on the transmitter; l denotes the perimeter of an antenna of the transmitter; ω is the signal angular frequency; and μ₀ is the permeability of free space.

The unit of A₀ in Equation (9) is Volt which is identical to the unit of induced electromagnetic signals at the receiver.

In some embodiments, the phase shift between the phases of the electrical signals measured at the transmitting signal coupler and the electromagnetic signals induced at the receiver can be expressed as Equation (10) below.

Δφ=φ−φ₀ (10)

where φ is the phase of the induced electromagnetic signals at the receiver; φ₀ is the phase of the electrical signals measured at the transmitting signal coupler.

The present invention is in no way limited to any particular order of steps or requires any particular step illustrated in FIG. 6.

In conclusion, exemplary embodiments of the present invention stated above may provide several advantages as follows. The present invention provides a compact logging apparatus, which can be deployed near a drill bit, for conducting at-bit resistivity measurements. The problem of measurement lag due to the distance between the drill bit and a traditional propagation logging tool can be eliminated accordingly.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims.

What is claimed is:

1. An apparatus for making resistivity measurements near a drill bit comprising:
a tool body;
a transmitter deployed on the tool body; wherein the transmitter generating electrical signals and converting the electrical signals into electromagnetic signals to be transmitted into a formation;
a receiver deployed on the tool body and at an axial distance from the transmitter; wherein the receiver measuring the amplitudes and phases of the electromagnetic signals sourced from the transmitter;
a transmitting signal coupler coupled to the transmitter; wherein the transmitting signal coupler coupling a portion of the electrical signals from the transmitter antenna and measuring the amplitudes and phases of the coupled electrical signals; and
wherein an amplitude attenuation and a phase shift between the electromagnetic signals received at the receiver and the electrical signals coupled at the transmitting signal coupler are computed for calculating resistivity.

2. The apparatus according to claim 1 wherein each of the transmitter and the receiver comprise at least one antenna for transmitting or receiving electromagnetic signals.

3. The apparatus according to claim 2 wherein the antenna is for converting electrical signals into electromagnetic signals or converting electromagnetic signals into electrical signals.

4. The apparatus according to claim 1 wherein the transmitter comprises a transmitter circuit configured to generate and amplify the electrical signals.

5. The apparatus according to claim 4 wherein the transmitter circuit comprises an impedance tuning circuit configured to adjust impedance within the transmitter.

6. The apparatus according to claim 1 wherein the receiver comprises a receiver circuit configured to process data of the amplitudes and phases of the electromagnetic signals sourced from the transmitter.

7. The apparatus according to claim 1 wherein the transmitting signal coupler comprises a coupling circuit configured to record the electrical signals coupled from the transmitter and help measure the amplitudes and phases of them.

8. The apparatus according to claim 1 further comprises a controller and processor module coupled to the transmitter, the transmitting signal coupler, and the receiver to control a measurement operation and calculate the amplitude attenuation and phase shift between the amplitudes and phases of the electromagnetic signals received at the receiver and the electrical signals coupled at the transmitting signal coupler.

9. The apparatus according to claim 8 wherein the controller and processor module is coupled with a storage device stored with a conversion chart for converting the computed amplitude attenuation and phase shift into corresponding formation resistivity.

10. A method for formation resistivity measurements near a drill bit comprising:
deploying a tool body in a borehole;
firing a transmitter to transmit electromagnetic signals into a formation;
utilizing a transmitting signal coupler to measure the amplitudes and phases of electrical signals generated on the transmitter antenna;
utilizing a receiver to measure the amplitudes and phases of the electromagnetic signals sourced from the transmitter; and
computing amplitude attenuation and phase shift based on the amplitudes and phases of the electrical signals measured at the transmitting signal coupler and the electromagnetic signals induced at the receiver.

11. The method according to claim 10 further comprises providing a conversion chart to facilitate converting the computed amplitude attenuation and phase shift into corresponding resistivity.

12. The method according to claim 10 wherein firing a transmitter to transmit electromagnetic signals into the formation comprises converting the electrical signals on the transmitter into the corresponding electromagnetic signals.

13. The method according to claim 10 wherein utilizing a transmitting signal coupler to measure the amplitudes and phases of electrical signals generated on the transmitter comprises utilizing the transmitting signal coupler to couple the electrical signals from the transmitter.

14. The method according to claim 10 wherein the amplitude attenuation between the amplitudes of the electrical signals measured at the transmitting signal coupler and the electromagnetic signals induced at the receiver is expressed by an equation
ρ=20 log(kA/A₀)
where A is the amplitude of the induced electromagnetic signals at the receiver, k is the geometry factor of the tool body, and A₀ is the amplitude of the electrical signals measured at the transmitting signal coupler.

15. The method according to claim 14 wherein A is expressed by an equation
A₀=Ilωμ₀/(16π³)
where I is current generated on the transmitter; l denotes a perimeter of an antenna of the transmitter; ω is the signal angular frequency; and μ₀ is a permeability of free space.

16. The method according to claim 10 wherein the phase shift between the phases of the electrical signals measured at the transmitting signal coupler and the electromagnetic signals induced at the receiver is expressed by an equation
Δφ=φ−φ₀
where φ is the phase of the induced electromagnetic signals at the receiver; φ₀ is the phase of the electrical signals measured at the transmitting signal coupler.

17. An apparatus for making at-bit resistivity measurements comprising:
a tool body;
a transmitter deployed on the tool body; wherein the transmitter generating electrical signals and converting the electrical signals into electromagnetic signals to be transmitted into a formation;
a receiver deployed on the tool body and at an axial distance from the transmitter; wherein the receiver measuring the amplitudes and phases of the electromagnetic signals sourced from the transmitter;
a transmitting signal coupler coupled to the transmitter; wherein the transmitting signal coupler coupling a portion of the electrical signals from the transmitter antenna and measuring the amplitudes and phases of the coupled electrical signals; and
a controller and processor module coupled to the transmitter, the receiver, and the transmitting signal coupler for controlling a measurement operation and computing an amplitude attenuation and a phase shift between the electromagnetic signals induced at the receiver and the electrical signals coupled at the transmitting signal coupler.

18. The apparatus according to claim 17 further comprises a storage device coupled to the controller and processor module and stored with a conversion chart to convert the computed amplitude attenuation and phase shift into corresponding resistivity.

19. The apparatus according to claim 17 wherein each of the transmitter and the receiver comprise at least one antenna.

20. The apparatus according to claim 17 wherein the transmitter comprises a transmitter circuit configured to generate and amplify electrical signals.
